(19) United States
(12) Patent Application Publication
(10) Pub. No.: US 2007/0292574 A1
(43) Pub. Date: Dec. 20, 2007

(54) CARBONATION VESSEL

(75) Inventors: Qingyue Ling, Tigard, OR (US); Galen D. Kaufman, Galveston, TX (US); Adam Lindemann, Ashiya City (JP)

Correspondence Address: CHERNOFF, VILHAUER, MCCLUNG & STENZEL, 1600 ODS TOWER, 601 SW SECOND AVENUE, PORTLAND, OR, 97204-3157, US

(73) Assignees: The Fizzy Fruit Company, Portland, OR (US); Oregon State University, Corvallis, OR (US)

(21) Appl. No.: 11/548,212

(22) Filed: Oct. 10, 2006

Related U.S. Application Data
(60) Provisional application No. 60/805,070, filed on Jun. 16, 2006.

(51) Int. Cl. A23B 7/148; B01F 3/04

(52) U.S. Cl. 426/474; 261/121.1; 261/DIG. 7

(57) ABSTRACT

A carbonation vessel comprising a container for holding a quantity of fruits or vegetables, an insert pan separating a lower space within the container from an upper space and having a gas vent for allowing gas to flow from the upper space to the lower space, a lid covering the upper space and a top opening of the container, a sealing member positionable between the lid and the top opening of the container, and at least one clamp for clamping the lid to the top opening of the container with the sealing member therebetween, thereby sealing the vessel. In one embodiment, the vessel can retain at least thirty pounds per square inch internal pressure. The internal pressure may comprise gaseous carbon dioxide generated in the upper space of the vessel by mixing sodium bicarbonate and citric acid with water, allowing sublimation of dry ice within the upper space, or other carbon dioxide gas generating means. The pressurized carbon dioxide, through absorption into the tissue of the fruits or vegetables, leaves the fruits or vegetables with an effervescent or “fizzy” quality. Various embodiments involve orientation of a gas vent inlet within the upper space so that tipping or inverting the vessel does not allow for the inlet to become blocked by reactants or other non-gaseous substances in the insert pan or upper space of the vessel.

### BACKGROUND OF THE INVENTION

The present invention relates to a carbonation vessel. More particularly, the present invention relates to a vessel for providing a pressurized gaseous carbon dioxide rich environment for carbonating a quantity of product such as, for example, fruits or vegetables.

A number of pressurizable container devices have been developed that may be capable of generating carbon dioxide gas, but these devices are developed for carbonating or re-carbonating beverages and do not address the particular needs involved in carbonating, for example, fruits or vegetables. These devices also tend to incorporate overly complex structures, which are directed to the absorption of gaseous carbon dioxide into a liquid beverage rather than the absorption of enough carbon dioxide into the tissue of fruits or vegetables so that the fruits or vegetables acquire an effervescent or “fizzy” quality.

For example, U.S. Pat. No. 5,549,037, by Stumphauzer et al., discloses (in its abstract) a portable lightweight gas generation device which can be attached to a container to generate a quantity of gas from a mixture of two chemically reactive materials and to inject the gas into the container. The device is especially useful as an apparatus for rapidly carbonating liquid beverages with chemically generated carbon dioxide produced in a gas generation chamber located inside a pressure vessel attached to a liquid container which serves as a carbonation chamber containing the liquid to be carbonated. The generated carbon dioxide is passed from the gas generation chamber to the carbonation chamber to carbonate the liquid. The device can also be used to inject pressurized gas into a pressurized spray can for dispensing liquids such as paint, hair spray or other sprayable products.

However, Stumphauzer is directed to a device that screws onto the threaded neck of a beverage container such as, for example, a two-liter plastic beverage container, and requires multiple chambers separate from the beverage container. The devices requires separate chambers for holding each of the reactive materials and a separate mixing chamber where carbon dioxide is generated. The device must be inverted or a more complex coil spring structure must be compressed in order to mix the reactants together and initiate the generation of carbon dioxide.

Both U.S. Pat. No. 4,458,584, by Annese et al., and U.S. Pat. No. 4,475,448, by Shoaf et al., which is a divisional of Annese et al. (U.S. Pat. No. 4,458,584), are directed to a particular beverage carbonating device. Annese et al., discloses (in its abstract) producing a substantially salt-free carbonated beverage using a pressurizable container comprising a carbonation chamber having an upper compartment for holding chemical reactants, a means for separating gaseous carbon dioxide and solid or liquid reaction by-products and a lower compartment having a bottom sparger surface for releasing, as uniformly small bubbles, the generated carbon dioxide into a liquid to be carbonated. The separation means and sparger surface function to retain the chemical by-products of the reaction from the carbonated beverage.

Shoaf et al. discloses (in its abstract) a separation means for isolating the resultant salts of a carbonation reaction while permitting the transfer of gaseous carbon dioxide in a substantially pure, non-contaminated form to a liquid to be carbonated. The separation means comprises a passageway with a plurality of restricted gas communicating apertures and a one-way valve attached to the end of the passageway which is proximate to the liquid to be carbonated. The gas communicating apertures and one-way valve function to retain the chemical by-products of the reaction from the carbonated beverage.

However, the particular device described in Annese et al. and Shoaf et al. requires various components such as O-rings, one-way valves, sparger surfaces, and so on, such components making the design of the device more complicated. Further, to intiate the carbonation reaction, the device must be inverted in order to cause the reactants to mix.

U.S. Pat. No. 4,316,409, by Adams et al., discloses another device for carbonating a beverage. Adams et al. discloses (in its abstract) a pressurizable container designed as a rigid receptacle in the shape of a wide mouth bottle adapted to receive a large cap or cover. A perforated basket is mounted inside the cover, and is accessible to water in the bottle when the vessel is turned upside down to an inverted position. A spring loaded, manually operated valve is provided in the cover to permit venting of carbon dioxide from the interior thereof after the water-based mixture within the container has become sufficiently carbonated by absorbing carbon dioxide released by contact of water with the solid carbonation source.

However, Adams et al. requires a solid source of carbonation such as a cylindrically shaped carbonated ice briquette, wherein the carbonated ice is a frozen product of water and gaseous carbon dioxide. The carbonated ice briquette is placed within the perforated basket mounted inside the cover of the vessel, and a beverage within the vessel is carbonated when the beverage comes into contact with the carbonated ice briquette.

None of these pressurizable container devices are suitable for carbonating a quantity of product such as, for example, fruits or vegetables. An appropriately designed carbonation vessel that provides a simple-to-use pressurized gaseous carbon dioxide rich environment would be useful, for example, for the carbonated fruits or vegetables products described in U.S. Pat. No. 5,968,573, U.S. patent application Ser. No. 10/857,043, U.S. Provisional Application Ser. No. 60/699,450, and U.S. patent application Ser. No. 10/304,197, all commonly owned or licensed by The Fizzy Fruit Company and herein incorporated by reference. The described carbonated fruits or vegetables products generally include fruits or vegetables that have absorbed enough carbon dioxide so that the fruits or vegetables have acquired an effervescent or “fizzy” quality. The absorbed carbon dioxide tends to remain absorbed within the tissue of the fruits or vegetables for a longer period of time when the carbonated fruits or vegetables are maintained in a pressurized carbon dioxide rich atmosphere.

What is needed, therefore, is an appropriately designed, simple-to-use carbonation vessel that is capable of providing a pressurized gaseous carbon dioxide environment for a quantity of product such as, for example, fresh-cut fruits or vegetables.

### SUMMARY OF THE INVENTION

A carbonation vessel is described herein that overcomes the shortcomings of the prior art, providing a simple to use vessel comprising a container for holding a quantity of fruits or vegetables, an insert pan separating a lower space within the container from an upper space and having a gas vent for allowing gas to flow from the upper space to the lower space, a lid covering the upper space and a top opening of the container, a sealing member positionable between the lid and the top opening of the container, and at least one clamp for clamping the lid to the top opening of the container with the sealing member therebetween, thereby sealing the vessel.

In one embodiment, the vessel can retain at least thirty (30) pounds per square inch (psi) internal pressure. The internal pressure may comprise gaseous carbon dioxide generated in the upper space of the vessel by mixing sodium bicarbonate and citric acid with water, allowing sublimation of dry ice within the upper space, or other carbon dioxide gas generating means. As the carbon dioxide is generated, it is allowed to fill the lower space of the vessel by flowing through the gas vent. The pressurized carbon dioxide, through absorption into the tissue of the fruits or vegetables, leaves the fruits or vegetables with an effervescent or “fizzy” quality.

In one embodiment, the lid, container, and insert pan comprise food grade stainless steel, and the insert pan includes a food grade silicone seal about its periphery. A hinged clamp ring may be used to seal the vessel during carbonation of its contents, and a pressure relief valve may be included for manual release of pressure after carbonation or automatic release of excess pressure during carbonation.

Various embodiments may involve orientation of a gas vent inlet within the upper space so that tipping or inverting the vessel does not allow for the inlet to become blocked by reactants or other non-gaseous substances in the insert pan or upper space of the vessel.

Alternative embodiments may involve repositioning the insert pan lower in the container so that the upper space comprises an upper portion of the container rather than space within and above the insert pan extending upward into a convexity of the lid.

The foregoing and other objectives, features, and advantages of the invention will be more readily understood upon consideration of the following detailed description of the invention taken in conjunction with the accompanying drawings.

### BRIEF DESCRIPTION OF THE DRAWINGS

For a more complete understanding of the present invention, the drawings herein illustrate examples of the invention. The drawings, however, do not limit the scope of the invention. Similar references in the drawings indicate similar elements.

FIG. 1 is a perspective view of a carbonation vessel according to one embodiment.

FIG. 2 is an exploded view of a carbonation vessel according to one embodiment.

FIG. 3 is a cross-sectional view of a carbonation vessel according to one embodiment.

FIG. 4 is a partial cross-sectional view of the carbonation vessel shown in FIG. 3 in an inverted orientation, according to one embodiment.

FIG. 5 is a partial cross-sectional view of the carbonation vessel shown in FIG. 3 tipped on its side, according to one embodiment.

### DETAILED DESCRIPTION OF PREFERRED EMBODIMENTS

In the following detailed description, numerous specific details are set forth in order to provide a thorough understanding of the present invention. However, those skilled in the art will understand that the present invention may be practiced without these specific details, that the present invention is not limited to the depicted embodiments, and that the present invention may be practiced in a variety of alternative embodiments. In other instances, well known methods, procedures, components, and systems have not been described in detail.

Various operations will be described as multiple discrete steps performed in turn in a manner that is helpful for understanding the present invention. However, the order of description should not be construed as to imply that these operations are necessarily performed in the order they are presented, nor even order dependent. Lastly, repeated usage of the phrase “in one embodiment” does not necessarily refer to the same embodiment, although it may.

As an overview, the present inventors set out to develop the concept of producing carbonated (or “fizzy”) fruits or vegetables for serving in school lunch programs. After considerable testing and experimentation, the present inventors determined that out of numerous different designs developed, particular designs provided satisfactory performance in terms of simplicity of design, easy of use, acceptable manufacturing feasibility, manageable costs, and so forth. One embodiment of a suitable carbonation vessel, in general terms, comprises a food grade container or body defining a lower area sized to hold approximately five pounds of fruit, a lid covering a top opening of the body, an insert pan having a seal for sealing the lid to the body and a gas vent for allowing gas to flow downward from an upper area above the insert pan to the lower area below the insert pan, and a clamp for securely holding the lid to the body. A quantity of water and tea bags (or sachets) containing sodium bicarbonate and citric acid may be placed within a water and bag area in the insert pan, thereby causing a release of carbon dioxide gas. The carbon dioxide gas fills the upper area above the insert pan and flows downward through the gas vent into the lower area, where the carbon dioxide gas is absorbed by the fruit causing the fruit to take on an effervescent or carbonated quality. The vessel may include a pressure release valve (and over pressure safety valve) and handles on the lid and body. In one embodiment, it was found that a vessel having therein between thirty (30) and forty (40) pounds per square inch (psi) of pressurized carbon dioxide is enough to adequately carbonate a portion of fresh-cut grapes.

The present inventors experimented with, in one embodiment, using a pellet (or several pellets) of dry ice for generating pressurized carbon dioxide within a vessel. However, it was determined that while such a pellet does comprise a suitable gas generating substance, and is, therefore, to be included as an acceptable gas generating substance in at least one embodiment, the handling of dry ice is not easily accommodated in typical fruit (or food) handling environments. The present inventors subsequently found that a dry powder mixture of sodium bicarbonate and citric acid (or other appropriate carboxylic base and acid) which when activated by water or a water-based solution would generate the requisite volume of carbon dioxide to pressurize the carbonation vessel.

The present inventors further determined that other combinations of gas generating substances and suitably corresponding liquids (or “reactants”) may be used with a suitably designed vessel for carbonating fruits or vegetables. In one embodiment, sodium bicarbonate and citric acid may be activated with water to generate carbon dioxide in a separated space within the vessel, and the separated space may be configured to prevent unreacted reactants and residual solution formed in the reaction from coming into contact with and possibly tainting the flavor of fruits or vegetables in the package. It was found that such contact may cause an unpleasant or salty taste in, for example, a “fizzy” fruit product.

Additional improvements are included, as will be discussed below for various embodiments, to provide safe operation and commercially viable characteristics for a carbonation vessel. Such improvements include, but are not limited to, a manually operated pressure release valve, an automatic over pressure release valve, food grade stainless steel components, food grade silicone seal material, a hinged clamp ring with locking features, and other aspects described or depicted in the drawings.

Reference to “a portion of fruits or vegetables” is used herein to refer to a portion of any one or any combination of the following: a single type of fruit, a mixture of different types of fruit, a single type of vegetable, a mixture of different types of vegetable, or a mixture of one or more types of fruit and one or more types of vegetable. For example, the fruits or vegetables may comprise fresh-cut whole grapes, de-stemmed grapes mixed with strawberries, a particular type of fruit mixed with a particular type of vegetable, or any other combination of fruits or vegetables. The fruits or vegetables may comprise fresh-cut or minimally processed fruits or vegetables but may also include fruits or vegetables that have been processed. The fruits or vegetables may comprise fruits or vegetables that have been carbonated before placement into the carbonation vessel.

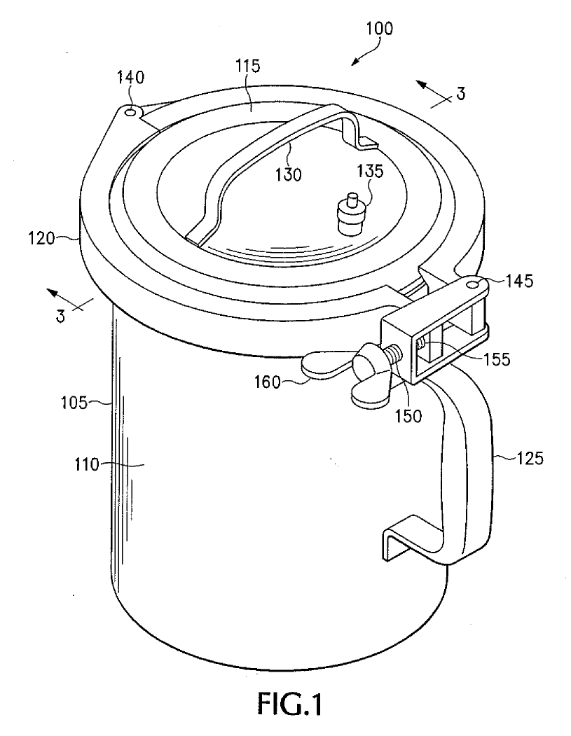

Turning now to the drawings, FIG. 1 is a perspective view of a carbonation vessel according to one embodiment. As shown in a fully closed orientation, a carbonation vessel 100 for carbonating fruits or vegetables (or other product or products) may comprise a container 105 defining a lower space 110 therein sized to hold a quantity of fruits or vegetables, an insert pan (hidden within the vessel) separating the lower space 110 from an upper space above the lower space 110 and having at least one gas vent (hidden in this view) for allowing gas to flow from the upper space to the lower space 110, a lid 115 covering the upper space and a top opening (hidden) of the container 105, a sealing member (also hidden) positionable between the lid 115 and the top opening of the container 105, and at least one clamp, such as the clamp ring 120 shown, that is capable of clamping the lid 115 to the top opening of the container 105 with the sealing member therebetween, thereby sealing the vessel 100. The vessel 100 may comprise, as shown, a substantially cylindrically shaped container 105 having a handle 125 thereon, within which container 105 a quantity of product such as fruits or vegetables may be placed. After placement of an insert pan, a sealing member, and gas generating substances (or reactants), all of which will be described in greater detail below, the lid 115 may be placed over the insert and sealing member, thereby covering the top opening in the container 105 and upper space between the insert pan and the lid 115. The clamp ring 120 may then be used to sealably and securely close the vessel 100. The lid 115 may include a handle 130 as well as a pressure relief valve 135.

Other configurations are possible. For example, the vessel 100 may include more than just one handle 125 on the container 105. The container 105 may include two handles, perhaps one on each side of the container 105. Likewise, the lid 115 may include more than one handle 130. The vessel 100 may incorporate a combination manual release and automatic over pressure release type valve 135. In one embodiment, the pressure relief valve 135 comprises a manually operated pressure relief valve or an automatic over pressure safety relief valve or a combination valve providing both manual operation as a pressure release valve and automatic operation as an over pressure safety valve.

However, the vessel 100, in one embodiment, may incorporate other over pressure release and manual pressure release features in addition to or in place of the valve 135 shown in FIG. 1. For instance, pressure within the vessel 100 may be controllably released using only a clamping device such as the hinged clamp ring 120. The clamp ring 120, as shown, includes a hinge 140, a hinged closing mechanism 145 on one end of the clamp ring 120, the hinged closing mechanism 145 having a threaded screw 150 for closeably tightening the hinged clamp ring 120 about the lid 115 and the top opening of the container 105 and a recess 155 on the other end of the hinged clamp 120 to receive the leading edge of the threaded screw 150. The threaded screw 150, in one embodiment, includes a wing-nut type end 160 to facilitate tightening the clamp ring 120 by hand. As the threaded screw 150 is loosened from a tightened or closed position, the clamp ring 120 begins to loosen, allowing separation of the lid 115 from the top opening of the container 105 and sealing member therebetween. In one embodiment, the vessel 100 does not include a valve 135 because operation of the clamp (such as clamp ring 120) may provide enough pressure release control. Further, over pressure may be released through pressure relief features incorporated into the sealing member used. Such features may include cuts in the sealing member, the sealing member comprising a food grade silicone ring formed about the periphery of the insert pan, whereby the cuts are designed to allow the release of pressure above a predetermined amount.

In one embodiment, the vessel 100 is designed for carbonating product within its lower space 110 so that at least thirty (30) pounds per square inch (psi) is maintained within the lower space 110. In one embodiment, the vessel 100 is designed to safely retain at least sixty (60) pounds per square inch (psi) of internal gaseous pressure without bursting or failing. In one embodiment, the valve 135 comprises an over pressure safety valve for automatically releasing excess pressure above a predetermined threshold. In one embodiment, the predetermined threshold is approximately forty-five (45) pounds per square inch), above which threshold pressure is released until the pressure within the vessel 100 drops below the threshold amount. As with any device operating as a switch or valve designed to open at a particular threshold pressure value and then close when pressure drops below the threshold value, a hysterisis may exist whereby the device opens at a particular pressure but then closes when the pressure drops by a predetermined amount (for example, 1 or 2 psi) below the threshold. Therefore, a pressure release valve 135 may be designed as an automatic over pressure safety valve to release pressure above a threshold value (ex. 45 psi) but operationally triggers at the threshold value (ex. 45 psi) and thereafter releases the excess pressure down to an amount below the trigger/threshold value (ex. 43 psi) at which point the valve closes to retain the remaining pressure. However, such operation is typical and such device is herein described as a pressure release valve for automatically releasing excess pressure over a predetermined amount.

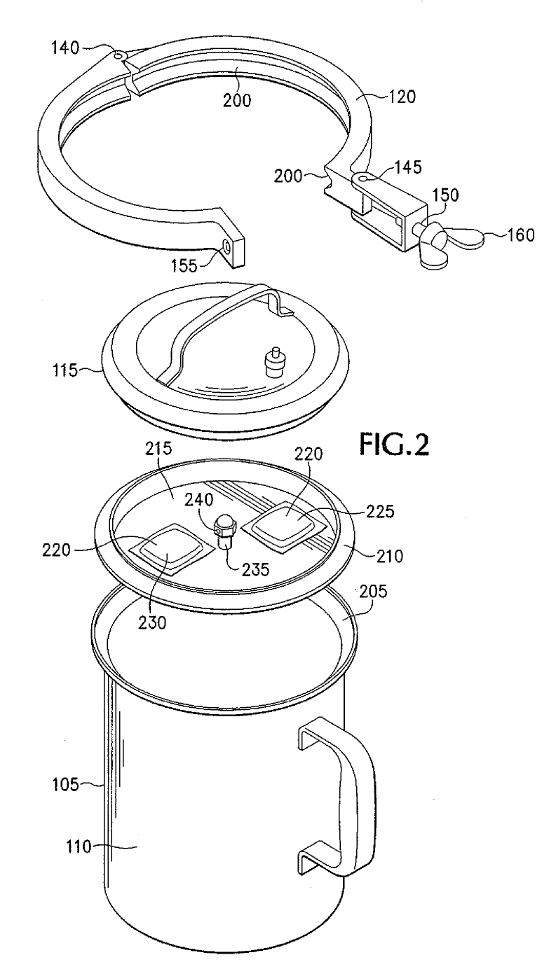

Next, FIG. 2 is an exploded view of a carbonation vessel according to one embodiment. The carbonation vessel, in one embodiment, comprises a clamp such as clamp ring 120, as shown. In one embodiment, the clamp ring 120 comprises two halves joined by a hinge 140 with a hinged closing mechanism 145 on one end having a threaded fastener 150 and wing-nut 160 thereon. The other end of the clamp ring 120, in one embodiment, comprises a recess 155 within which the threaded fastener 150 may be lockably inserted. Tightening the threaded fastener 150 about the two ends of the clamp ring 120 compresses the two halves of the clamp ring 120 together. In one embodiment, the clamp ring 120 includes a V-shaped or U-shaped channel 200 which operates to compress together and securely seal the lid 115 to the top opening 205 of the container 105 with a sealing member 210 therebetween.

Clamp ring 120 may comprise any of a wide variety of clamp ring designs. For example, a non-hinged clamp ring may be used that is similar in design to clamp rings used with filtration systems. A clamp ring 120 may be used that incorporates a quick-release type of closing mechanism, similar to quick-release mechanisms used on bicycles, instead of the wing-nut 160 and threaded fastener 150. Other clamping devices may be used. For example, instead of the hinged type clamp ring 120 shown in FIG. 2, a combination of two or more latch-down type clamps may be affixed to the lid 115 and simply latch downward, engaging tabs affixed to the container 105, similar to the latch-down type mechanisms used for tool boxes and other storage containers.

In one embodiment, the carbonation vessel comprises a clamp such as the clamp ring 120, a lid 115, an insert pan 215, and a container 105, as shown in FIG. 2. The insert pan 215 shown provides separation between the lower space 110 within the container 105 and an upper space that includes holding space within the insert pan and space above the bottom of the insert pan extending upward toward the lid 115. In one embodiment, the insert pan 215 is capable of holding gas generating reactants for generation within the upper space of pressurized gas. In one embodiment, the reactants comprise a quantity of liquid and at least one sachet 220 permeable to the liquid, whereby the reactants are capable of generating enough carbon dioxide gas to fill the upper and lower spaces of the vessel with pressurized carbon dioxide when the reactants are mixed together within the upper space. In one embodiment, the liquid comprises water, one sachet 225 comprises sodium bicarbonate in a water permeable sachet (or tea bag), and another sachet 230 comprises citric acid in a water permeable sachet (or tea bag). When the water, sodium bicarbonate, and citric acid are mixed together (in the holding space within the insert pan 215) carbon dioxide gas is generated. The carbon dioxide gas fills the upper space above the insert pan 215 and is allowed to flow downward into the lower space 110 through a gas vent 235 formed upon the insert pan 215. In one embodiment the gas vent 235 comprises a tubular protrusion extending upward from the bottom of the insert pan 215 so that a gas vent inlet 240 upon the tubular protrusion is positioned at a height above the bottom of the insert pan 215 to avoid becoming blocked by the reactants or non-gaseous material within or on the insert pan 215.

In one embodiment, the sealing member 210 comprises a food grade silicone ring sized to fit between the peripheries of the lid 115 and the top opening 205 of the container 105. In one embodiment, the sealing member 210 is affixed about the circumference or periphery of the insert pan 215 to simplify the handling of components and usage of the carbonation vessel. In one embodiment, the clamp ring 120, the lid 115, the insert pan 215, and the container 105 comprise a food grade stainless steel construction, and the sealing member 210 comprises a food grade silicone material formed upon the insert pan 215. Other materials may be used for these components.

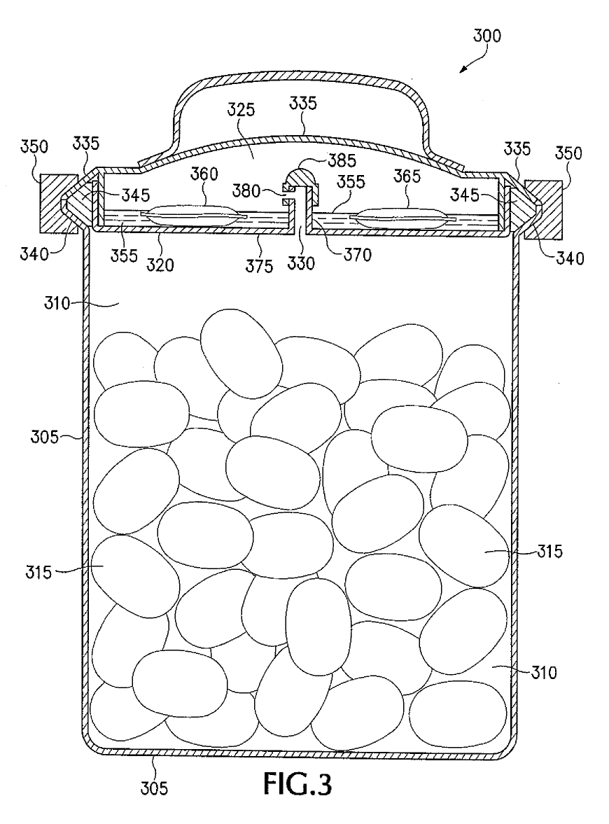

FIG. 3 is a cross-sectional view of a carbonation vessel 300 at the cut line shown in FIG. 1, according to one embodiment. In one embodiment, the carbonation vessel 300 comprises a container 305 having a lower space 310 sized to hold a quantity of fruits or vegetables 315, an insert pan 320 separating the lower space 310 from an upper space 325 and having a gas vent 330 for allowing gas to flow from the upper space 325 to the lower space 310, a lid 335 covering the upper space 325 and a top opening 340 of the container 305, a sealing member 345 positionable between the lid 335 and the top opening 340 of the container 305, and at least one clamp 350 capable of sealing the vessel 300 by clamping the lid 335 to the top opening 340 of the container 305 with the sealing member 345 therebetween.

A method of carbonating fruits or vegetables using the carbonation vessel 300, according to one embodiment, comprises the steps of: providing the carbonation vessel 300 and the quantity of fruits or vegetables 315 to be carbonated; placing the quantity of fruits or vegetables 315 into the lower space 310 of the container 305; placing the insert pan 320 over the lower space 310 of the container 305; adding carbon dioxide generating reactants (such as, for example, water 355, a sodium bicarbonate sachet 360, and a citric acid sachet 365) to the upper space 310 over the insert pan 320; closing the lid 335 over the upper space 325 and the top opening 340 of the container 305; clamping the lid 335 to the top opening 340 of the container 305 with the sealing member 345 therebetween using the clamp 350; and waiting a predetermined amount of time to allow generated pressurized carbon dioxide gas to be absorbed by the tissue of the fruits or vegetables 315. In one embodiment, the carbon dioxide generating reactants comprise approximately one hundred (100) milliliters or a quarter cup of water 355 and two sachets, a sodium bicarbonate sachet 360 and a citric acid sachet 365, together, having a net weight of approximately seventy (70) grams.

The method further comprises, according to one embodiment: releasing pressure from the vessel 300 after a sufficient amount of carbon dioxide gas has been absorbed by the fruits or vegetables 315 so that the fruits or vegetables 315 acquire an effervescent quality, the releasing of pressure by opening a pressure release valve (such as valve 135) mounted upon the vessel 300 and then removing the clamp 350 or, alternatively, by opening the clamp 350 enough to release pressurized carbon dioxide from within the vessel 300; removing the clamp 350 to expose the upper space 325 and the insert pan 320 therein; and removing the insert pan 320.

In one embodiment, the method further comprises: removing the quantity of fruits or vegetables 315 from the lower space 310 of the container 305; and serving the quantity of fruits or vegetables 315 to one or more consumer or, before the serving step, pouring the quantity of fruits or vegetables 315 onto a serving tray, spreading the quantity of fruits or vegetables 315 to fill a plurality of individual serving cups cooperatively aligned below serving cup sized holes in the serving tray, thereby filling the plurality of individual serving cups with the quantity of fruits or vegetables 315.

The above method steps may be performed in the sequence described or in different orders. For example, the step of adding carbon dioxide generating reactants to the upper space 325 over the insert pan 320 may be performed before or after the step of placing the insert pan 320 over the lower space 310 of the container 305. Moreover, additional steps may be performed between the above method steps, depending upon the particular needs of a user of the carbonation vessel 300. For example, sugars, sweetners, or perhaps vitamins or nutrients may be added to the lower space 310 along with the quantity of fruits or vegetables 315. Or, if, for example, the sealing member 345 comprises a separate component (i.e. not integrally formed upon, affixed to, or mounted to the insert pan 320), the sealing member 345 may be appropriately placed before securely sealing closed the carbonation vessel to allow carbonation of the fruits or vegetables 315 therein. Other changes to the method steps disclosed herein may be made without compromising the spirit of the method of using a carbonation vessel as disclosed herein.

The order of adding carbon dioxide generating reactants to the upper space of the vessel is unimportant. The water 355 may be added, followed by addition of the sodium bicarbonate 360 and citric acid 365 sachets, or the sachets may be added first and followed by addition of the water. Of course if other reactants or carbon dioxide generating substances are used, different method steps will be needed. For example, if the reactants comprise a liquid and a single sachet containing a dry powder mixture that, when combined with the liquid, generate carbon dioxide gas, then these reactants may be put into the insert pan in any order as long as the reactants are allowed to generate enough pressurized carbon dioxide gas within the sealed carbonation vessel so that the tissue of the fruits or vegetables within the vessel acquire an effervescent or “fizzy” quality.

Also shown in FIG. 3 is additional detail for the gas vent 330, according to one embodiment. In one embodiment, the gas vent 330 comprises a tubular protrusion 370 extending upward from the bottom 375 of the insert pan 320 so that a gas vent inlet 380 upon the tubular protrusion 370 is positioned at a height above the bottom 375 of the insert pan 320 to avoid becoming blocked by the reactants or non-gaseous material within or on the insert pan 320. In one embodiment, the gas vent inlet 380 comprises an orifice sized just large enough to allow the flow of gas from the upper space 325 to the lower space 310 within the container 305 and oriented to minimize a likelihood of becoming blocked by the reactants or non-gaseous material within the upper space 325. In one embodiment, the orifice is approximately three (3) millimeters in diameter, and the tubular protrusion 370 has a diameter of approximately eight (8) millimeters.

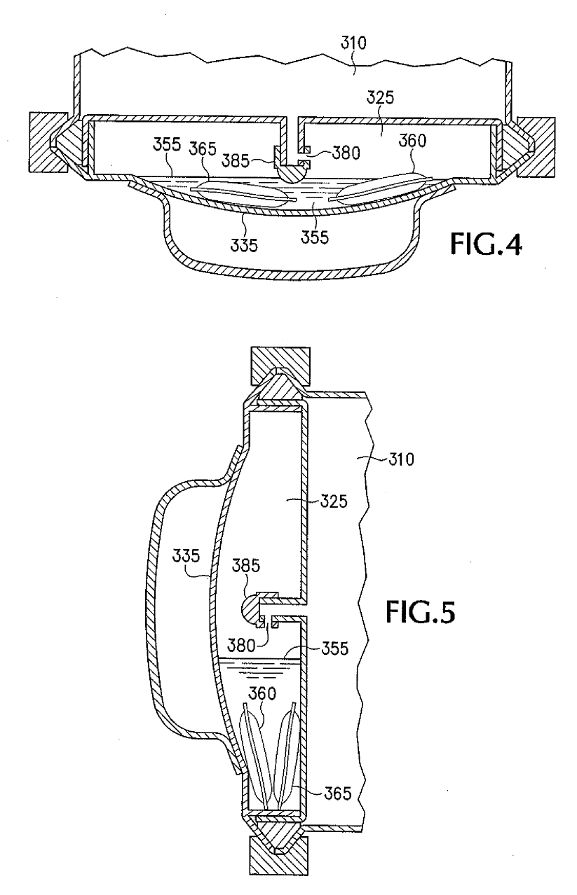

In one embodiment, the orifice of the gas vent inlet 380 comprises an opening in a nut 385 threadably fastened to cooperatively mating threads upon the tubular protrusion 370 extending from the bottom surface 370 of the insert pan 320, the opening in the nut 385 having a pathway through the tubular protrusion 370 capable of allowing gas to freely flow between the upper space 325 and the lower space 310. In one embodiment, the gas vent inlet 380 is positioned substantially centrally upon the insert pan 320 and at a height above the bottom surface 375 of the insert pan 320 and below surfaces of the lid 335 so that the gas vent inlet 380 does not become blocked by the reactants or non-gaseous material even when the sealed vessel 300 is tipped on its side (as shown in FIG. 5) or further tipped to an inverted orientation (as shown in FIG. 4).

FIG. 4 is a partial cross-sectional view of the carbonation vessel 300 shown in an inverted orientation, according to one embodiment. As shown, the reactants have collected into the space between the nut 385 and the surfaces of the lid 335. In particular, according to one embodiment, the water 355 and sachets 360, 365 have collected into the space between the nut 385 and the surfaces of the lid 335, but the gas vent inlet 380 remains unblocked so that gas may still flow from the upper space 325 into the lower space 310.

Finally, FIG. 5 is a partial cross-sectional view of the carbonation vessel 300 shown tipped on its side, according to one embodiment. As shown, the reactants have collected into one side below the nut 385. In particular, according to one embodiment, the water 355 and sachets 360, 365 have collected into the space below the nut 385, but the gas vent inlet 380 remains unblocked so that gas may still flow from the upper space 325 into the lower space 310.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A carbonation vessel for carbonating fruits or vegetables, said vessel comprising:
a container defining a lower space sized to hold a quantity of fruits or vegetables;
an insert pan separating said lower space from an upper space and having at least one gas vent for allowing gas to flow from said upper space to said lower space;
a lid covering said upper space and a top opening of said container;
a sealing member positionable between said lid and said top opening of said container; and
at least one clamp capable of clamping said lid to said top opening of said container with said sealing member therebetween, thereby sealing said vessel.

2. The vessel of claim 1, wherein said vessel is capable of holding a positive pressure of at least thirty pounds per square inch.

3. The vessel of claim 1, wherein said vessel is designed to safely retain at least sixty pounds per square inch of internal gaseous pressure, said vessel including an over pressure safety valve for automatically releasing excess pressure above approximately forty-five pounds per inch, said vessel further designed for carbonation of said fruits or vegetables within said lower space at an internal pressure of at least thirty pounds per square inch.

4. The vessel of claim 1, wherein said insert pan is capable of holding gas generating reactants for generation within said upper space of pressurized gas.

5. The vessel of claim 4, wherein said reactants comprise a quantity of a liquid and at least one sachet permeable to said liquid, said reactants capable of generating enough carbon dioxide gas to fill said upper and lower spaces with pressurized carbon dioxide when said reactants are mixed together within said upper space.

6. The vessel of claim 5, wherein said liquid comprises water, one sachet comprises sodium bicarbonate, and another sachet comprises citric acid.

7. The vessel of claim 4, wherein said wherein said reactants comprise at least one pellet of dry ice capable of sublimating within said upper space, thereby generating enough carbon dioxide gas to fill said upper and lower spaces with pressurized carbon dioxide gas.

8. The vessel of claim 5, wherein said gas vent includes an inlet positioned above said quantity of water and sachets so that gas generated within said upper space is able to flow from said upper space into said lower space without said gas vent inlet from becoming blocked by reactants or non-gaseous material on said insert pan.

9. The vessel of claim 8, wherein said gas vent comprises a tubular protrusion of a bottom surface of said insert pan, said tubular protrusion extending upward into said upper space, and said gas vent inlet comprises an orifice upon said tubular protrusion.

10. The vessel of claim 9, wherein said orifice is sized just large enough to allow the flow of gas from said upper space to said lower space within said container and oriented to minimize a likelihood of becoming blocked by said reactants or non-gaseous material within said upper space.

11. The vessel of claim 10, wherein said orifice comprises an opening in a nut threadably fastened to cooperatively mating threads upon said tubular protrusion extending from said bottom surface of said insert pan, said opening in said nut having a pathway through said tubular protrusion capable of allowing gas to freely flow between said upper space and said lower space.

12. The vessel of claim 8, wherein said gas vent inlet is positioned substantially centrally upon said insert pan and at a height above a bottom surface of said insert pan and below surfaces of said lid so that said gas vent inlet does not become blocked by said reactants or non-gaseous material even when said sealed vessel is tipped on its side or further tipped to an inverted orientation.

13. The vessel of claim 1, wherein said lower space is sized to hold approximately five pounds of fruits or vegetables.

14. The vessel of claim 1, wherein said sealing member is mounted about the circumference or periphery of said insert pan.

15. The vessel of claim 14, wherein said sealing member comprises a food grade silicone material.

16. The vessel of claim 1, wherein said clamp comprises a hinged clamp ring.

17. The vessel of claim 16, wherein said hinged clamp ring includes a hinged closing mechanism on one end of said hinged clamp ring, said hinged closing mechanism having a threaded screw for closeably tightening said hinged clamp ring about said lid and said top opening of said container with said sealing member therebetween, and a recess on the other end of said hinged clamp ring to receive said threaded screw.

18. The vessel of claim 1, wherein said container, said lid, said insert pan, and said clamp comprise a food grade stainless steel material.

19. The vessel of claim 1, further comprising a pressure release valve capable of manual operation to release pressure from within said upper and lower spaces and automatic operation to release excess pressure over a predetermined amount.

20. The vessel of claim 19, wherein said predetermined amount is forty-five pounds per square inch.

21. The vessel of claim 1, wherein said lid and said container each comprise at least one handle.

22. A method of carbonating fruits or vegetables using a carbonation vessel comprising a container having a lower space sized to hold a quantity of fruits or vegetables, an insert pan separating said lower space from an upper space and having a gas vent for allowing gas to flow from said upper space to said lower space, a lid covering said upper space and a top opening of said container, a sealing member positionable between said lid and said top opening of said container, and at least one clamp capable of sealing said vessel by clamping said lid to said top opening of said container with said sealing member therebetween, said method comprising:
providing said carbonation vessel and said quantity of fruits or vegetables to be carbonated;
placing said quantity of fruits or vegetables into said lower space of said container;
placing said insert pan over said lower space of said container;
adding carbon dioxide generating reactants to said upper space over said insert pan;
closing said lid over said upper space and said top opening of said container;
clamping said lid to said top opening of said container with said sealing member therebetween using said clamp; and
waiting a predetermined amount of time to allow generated pressurized carbon dioxide gas to be absorbed by the tissue of said fruits or vegetables.

23. The method of claim 22, farther comprising:
releasing pressure from said vessel after a sufficient amount of carbon dioxide gas has been absorbed by said fruits or vegetables so that said fruits or vegetables acquire an effervescent quality, said releasing pressure by opening a pressure release valve mounted upon said vessel and then removing said clamp or, alternatively, by opening said clamp enough to release pressurized carbon dioxide from within said vessel;
removing said clamp to expose said upper space and said insert pan therein; and
removing said insert pan.

24. The method of claim 23, further comprising:
removing said quantity of fruits or vegetables from said lower space of said container; and
serving said quantity of fruits or vegetables to one or more consumer or, before said serving, pouring said quantity of fruits or vegetables onto a serving tray, spreading said quantity of fruits or vegetables to fill a plurality of individual serving cups cooperatively aligned below serving cup sized holes in said serving tray, thereby filling said plurality of said individual serving cups with said quantity of fruits or vegetables.

25. The method of claim 22, wherein said carbon dioxide generating reactants comprise a quantity of a liquid and at least one sachet permeable to said liquid, said reactants capable of generating enough carbon dioxide gas to fill said upper and lower spaces with pressurized carbon dioxide when said reactants are mixed together within said upper space.

26. The method of claim 25, wherein said liquid comprises water, one sachet comprises sodium bicarbonate, and another sachet comprises citric acid.

27. An apparatus having means for carbonating fruits or vegetables, said apparatus comprising:
means for holding a quantity of fruits or vegetables;
means for separating carbon dioxide generating reactants from said quantity of fruits or vegetables;
means for retaining pressurized carbon dioxide generated by said carbon dioxide generating reactants so that the tissue of said quantity of fruits or vegetables is able to absorb enough of said pressurized carbon dioxide for said fruits or vegetables to acquire an effervescent or “fizzy” quality; and
means for safely removing said quantity of fruits or vegetables from said holding means after said quantity of fruits or vegetables have been carbonated.
